(19) United States
(12) Patent Application Publication
(10) Pub. No.: US 2002/0023108 A1
(43) Pub. Date: Feb. 21, 2002

(54) AUTOMATIC WEB FORM INTERACTION PROXY

(76) Inventors: NEIL DASWANI, EDISON, NJ (US); SUMAN KUMAR INALA, SANTA CLARA, CA (US); RAMAKRISHNA SATYAVOLU, SANTA CLARA, CA (US); P. VENKAT RANGAN, SAN DIEGO, CA (US)

Correspondence Address: CENTRAL COAST PATENT AGENCY, PO BOX 187, AROMAS, CA, 95004, US

(21) Appl. No.: 09/393,853

(22) Filed: Sep. 9, 1999

(51) Int. Cl. G06F 17/00

(52) U.S. Cl. 707/507

(57) ABSTRACT

An Internet-based subscription service accumulates and stores data pertinent to subscribers and subscriber's WEB destinations, monitors the subscriber's WEB browsing activities, and submits completed forms for the subscribers transparent to the subscribers. The forms may be log-in forms including passwords, and the service may periodically manage and alter security data such as passwords for a subscriber to enhance WEB security. In one aspect the service monitors subscribers filling out forms for the first time, then caches form information for subsequent use in submitting completed forms for the subscribers. In another aspect the service recognizes variable information required in forms, completes a proxy form with available information at the service, and then submits the proxy form to the subscriber to fill in the variable information before submitting the proxy form on behalf of the subscriber.

### FIELD OF THE INVENTION

The present Invention is in the field of network navigation including navigation on the Internet and other switched-data-packet networks and pertains more particularly to methods and apparatus for network caching of form data as applied to on-line digital forms, and subsequent automated provision of the form data when required during form preparation.

### BACKGROUND OF THE INVENTION

The information network known as the World Wide Web (WWW) which is a subset of the well-known Internet, is arguably the most complete source of publicly-accessible information available. Anyone with a suitable Internet appliance such as a personal computer with an Internet connection may connect (go on-line), navigate to, and download stored information from WEB pages.

WEB pages are stored on Internet-connected servers for the purpose of enabling presentation of organized information to users and allowing such users to interact with them in order to garner additional information through subsequent pages. WEB pages typically have interactive links to other associated WEB pages stored in the same server or on a different server. The addresses for such links are termed universal resource locators (URLs) by those familiar with the art. A URL is assigned to a WEB page as an address, which indicates where the page is held on the network, and provides a means for a browser to locate and connect to the WEB page of interest.

Information travels over the Internet network through many connected computers sometimes known as nodes in the art. Internet nodes include any hosted machines dedicated to performing a service such as file serving, data storing, data routing, and so on. Many nodes are dedicated to data routing. Such nodes are generally loosely associated with each other only by network address and mapped network paths.

Most data requested by users navigating a network such as the Internet is served in the form of an information WEB page, which has a unique URL address. WEB pages may be public or private in nature with some requiring passwords to gain access, or held in secure networks protected by a firewall. Some data initiated by or requested by users is transmitted without security measures and is not protected from being intercepted by some network-connected nodes and, perhaps being observed by third parties, due to the nature of publicly-shared bandwidth over the Internet. However, various means for protecting such data from being observed by third parties are established and routinely practiced by hosting entities. Such methods include the use of firewall technology, secure servers, authenticated digital forms, and private sub-networks connected to the Internet network.

Many companies doing business on the Internet host semi-private data networks comprising a plurality of computer nodes dedicated to the provision of proprietary information and related data. Certain authorized users such as those working for the company or those having password access and/or active and verifiable accounts with the company may access and view such data. For example, a large company may host a plurality of file servers, including connected data storage systems wherein users may search for and access data stored for the purpose by the company. Such sub-nets, as they are often termed, use the Internet as a connective wide area network (WAN) that bridges the information source and the user.

Still other companies provide services directed to allow users to access frequently visited WEB pages that are cached in a data store for the purpose and delivered by servers known in the art often as portal servers. A user may subscribe to a portal server and configure the server's network address into his or her navigational software. If using a portal server while navigating such as the Internet, the server recognizes when a user attempts to access a cached WEB page. When recognition is made, the server serves a cached version of the page saving the user download time. In many cases, WEB pages cached by portal service are periodically updated for new content.

Users that routinely practice Internet navigation or navigation on other similar networks are typically subscribed to a plurality of hosted services wherein a login and password are required to gain access to the WEB page bearing the subscribed-to data. Other types of login and password requirements exist with such as for e-mail accounts, membership pages, and so on. Furthermore, on-line shopping sites often require secure forms to be filled out with every purchase. Registering software and the like on-line also typically requires the use of form data. Much of the data supplied by users for the purpose of preparing such digital forms is repetitive in nature. Name, address, phone, place of business, and the like must be entered every time a user decides to make a purchase, register software, apply for an on-line loan, and so on.

A user subscribing to many on-line services or membership pages must also manage a significant number of different passwords required to access individual sites. Although there are software programs a user can purchase to store and manage many passwords, much maintenance is still required to change them regularly in order to enhance security.

Although using a portal server to obtain cached versions of WEB pages shortens navigational and download time for a user, such servers are only adapted to serving entire WEB pages. If a served page contains on-line digital forms of the general type described above, the user must still populate the forms with the required data.

What is clearly needed is a server that is enhanced with a form-recognition and data-population capability such that the server may supply the required user data for transparent login to subsequent WEB pages, and also, for preparation of a variety of on-line forms on behalf of a user. Such a system would benefit a user by simplifying and speeding up network navigation sessions, eliminating much download time associated with accessing WEB pages in order to fill out on-line forms. The system would also provide convenient management services for managing password and personal user data.

### SUMMARY OF THE INVENTION

In a preferred embodiment of the present invention a subscription server system is provided, comprising an Internet-connected subscription server; a user station subscriber to the subscription server, the user station enabled to connect-to the Internet and to invoke Universal Resource Locators (URLs) for WEB server destinations on the Internet; and a data repository accessible to the subscription server storing data pertinent to the user station. The subscription server monitors URL destinations invoked by the user station and pages served by the WEB server destinations to the user station as a result of the URLs invoked, intercepts forms requested by the WEB server destinations, populates fields in the forms with data from the data repository pertinent to the user station, and submits the forms to the requesting WEB server destinations on behalf of the user station, transparent to the user station.

In an embodiment of the invention one of the forms populated by the subscription server for the user station may be a log-in form requested by one of the WEB server destinations. Form data is submitted in one embodiment by user/subscribers in user profiles stored in the data repository and accessed by the subscription server to fill out forms. In another the subscription server identifies forms served to the user, and after a user fills out a form, the subscription server copies and stores the form and the data for future use. In some cases the subscription server, in monitoring user activity, recognizes a form previously requested by a WEB server destination and filled out by the user, and retrieves the stored copy of the filled-out form and communicates it to the requesting server.

In some embodiments the user performs a single log-in for the subscription server, and the subscription server, through pre-stored data associated with the user, provides subsequent log-ins for the user during a browsing session. The subscription server may also change passwords on a pre-programmed basis for the user, thereby enhancing user security.

In yet another embodiment the subscription server is enhanced by a form-recognition module enabled to store standards for forms and to use the standards to recognize subsequent forms. In still another embodiment the subscription server recognizes fields requiring variable information in a form, provides user information for fields requiring non-variable information, and submits the form to the user to fill in the variable information.

In another aspect of the invention a software suite for a subscription server serving as a browsing proxy for a user is provided, the software suite comprising a data storage and retrieval module enabled to communicate with a data repository wherein are stored copies of forms filled out by the user; a form-recognition module enabled to recognize blank forms served to the user by a requesting WEB server as equivalent to individual ones of the stored forms; and a substitution module enabled to retrieve a filled-out form copy of a blank form served to a user, and to submit the filled-out copy to the requesting server on behalf of the user, transparent to the user.

In some embodiments the form-recognition module monitors the process of a user filling in a form, and the storage and retrieval module, after the user once fills in the form, stores data particular to the form to be used the next time the form is recognized in conjunction with the user. There may further be a password module that stores passwords particular to a user and the user's WEB destinations, and submits the passwords for the user, transparent to the user. The password module may change passwords for the user periodically, enhancing security for the user.

In some embodiments of the software suite the form-recognition module recognizes fields requiring variable information in a form, provides user information for fields requiring non-variable information, and submits the form to the user to fill in the variable information.

In another aspect a method is provided for relieving subscribers of repeated form-filling tasks in WEB browsing, comprising steps of (a) monitoring a subscriber's browsing activity on the WEB by software on a subscription server; (b) recognizing, by the subscription server, a form sent to the subscriber by a WEB server for the subscriber to fill out; (c) retrieving from a data repository data pertinent to the subscriber and the form; and (d) submitting, by the subscription server to the WEB server, a filled-out form on behalf of the subscriber. In this method in some embodiments, in step (b) the subscription server recognizes in addition that the form has fields requiring variable information not available to the subscription server, and further comprising a step for filling in non-variable information and submitting the form to the subscriber to fill in the variable information before submitting the form to the requesting server on behalf of the subscriber.

In yet another aspect a method is provided for enhancing security for a person browsing the WEB, comprising steps of (a) configuring the person as a subscriber to a WEB-based subscription service with a single secure log in procedure; (b) storing for the person security data associated with individual ones of frequent WEB destinations; (c) monitoring the person's WEB browsing activity; and (d) submitting for the person for the WEB destinations when recognized, the security data associated with the person and the WEB destination. In this method the security data for the person may be altered on a periodic basis to further enhance security for the person.

In the various embodiments of the invention taught in enabling detail below for the first time an Internet-based subscription service is provided that significantly reduces the work load of form-filling required of WEB browsing persons, and also significantly enhances security for the same persons.

### BRIEF DESCRIPTION OF THE DRAWING FIGURES

FIG. 1 is an overview of a communication network enhanced with a form-recognition and data-population software according to an embodiment of the present invention.

FIG. 2 is a block diagram illustrating form-recognition and datapopulation software capabilities of the software of FIG. 1 according to an embodiment of the present invention.

FIG. 3 is a process flow diagram illustrating logical steps for form recognition and storage of values associated with a new request according to an embodiment of the present invention.

FIG. 4 is a process flow diagram illustrating logical steps for form recognition and data population associated with a repeat request according to an embodiment of the present invention.

### DESCRIPTION OF THE PREFERRED EMBODIMENTS

According to an embodiment of the present invention, the inventors provide a unique software capability that enables, for example, a portal server to recognize and store data supplied by a user filling out an on-line form such that the data may be re-populated to such forms the next time a user desires to interact with them. The method and apparatus of the present invention is disclosed in enabling detail below.

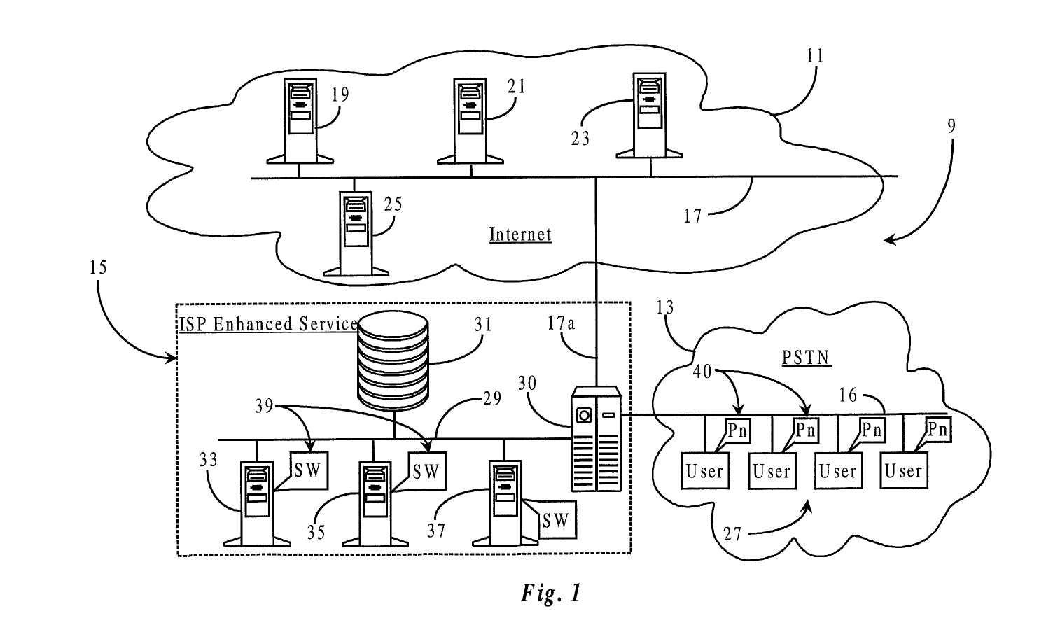

FIG. 1 is an overview of a communication network 9 enhanced with a form-recognition and data-population software (SW) 39 according to an embodiment of the present invention. Communication network 9 in this embodiment comprises an Internet network 11, a public-switched telephone network (PSTN) 13, and an Internet service provider (ISP) 15.

Internet network 11 may be any other type of switched data-packet network (SDPN) that is known in the art, such as a private or public-access Intranet. The only requirements are that it is adapted for communication using an acceptable network protocol such as transfer control protocol/Internet protocol (TCP/IP) and supports hyper-text-markup-language (HTML) or another suitable language that enables the service of graphical information pages to user's operating connected personal computers or other compatible network appliances. The Internet is represented herein as a preferred network for practice of the present invention.

Illustrated in network 11 are a plurality of server nodes 19, 21, 23 and 25 that are adapted to serve information pages known generally as WEB pages, and which are familiar to those of ordinary skill in the art of Internet navigation. Servers 19-25 may contain information pages hosted by any public or private entity. WEB pages contained therein may themselves contain password log-in forms that are required to be filled out before a next page associated with the log-in page will be served. Similarly, a host of other types of digital data-forms may be contained in such WEB pages. For example, WEB-hosted banking systems require a user to enter account numbers and PIN numbers to gain access to bank account data. Servers 19-25 are connected to each other by Internet backbone 17.

PSTN 13 may be a any type of connection-orientated-switched telephony (COST) network, including private telephone networks. A plurality of users 27 are illustrated as connected to a telephony trunk line 16, which represents all such telephony lines and connections in PSTN 13.

Each user 27 may be assumed to be connected to Internet network 11 by virtue of typical Internet connective apparatus and method as is generally known in the art. For example, each user 27 uses an Internet appliance such as a computer equipped with a modem and appropriate software for accessing Internet 11. Typically, users 27 gain access to network 11 through ISP 15, which represents the most common access mechanism for most users. In other embodiments, other known methods and apparatus may be used to accomplish Internet connections, including wireless mobile connection, continual corporate connections, and the like.

ISP 15, in this example, maintains an enhanced service for it's customers. For example, a main ISP server 30 is provided and adapted to provide conventional Internet services to users 27. A separate digital network 29 is provided and connected to Internet 11 through main server 30. Main server 30 shares connection to sub-network 29 along with a plurality of other servers 33, 35, and 37 in this example. Servers 33-37 are dedicated in part to serving cached information pages requested by a user 27 instead of requiring a complete negotiation with one of servers 19-25 in network 11. The use of portal servers such as servers 33-37 to accomplish caching of pages is generally known in the art and was described briefly in the background section.

To illustrate a general implementation, a user configures the parameters of a portal server into his or her navigation software (browser). When the user connects on-line, the server monitors the user's activity such that when a user invokes a URL to a destination, the server checks the URL against a cache of repeatedly-visited URLs held typically on behalf of the user. If a URL matches one in cache, the server serves the WEB page from the cache instead of requiring a negotiation with the original remote server hosting the page. In this way a service is created whereby navigational time on a network may be reduced for clients using the service. The function of caching in this context is quite similar to the functioning of cache memory in a computer architecture.

Such a portal service may be hosted by an entity other than an ISP as is illustrated here. A company, membership organization, government body, or a private entity may maintain and provide such services.

In this embodiment, individual ones of portal servers 33-37 are enhanced with a unique software capability by virtue of provided software (SW) instances 39 illustrated as installed on servers 33-37. Software instance 39 provides enhanced capability to portal servers 33-37 that is not known or practiced in prior art. Prior art servers are adapted to recognize and cache WEB pages based on matching URLs. This process is transparent to a user and no other communication exists between such a portal server and a user.

Software 39 adds a unique ability to servers 33-37 for recognizing cached data-pairs typically associated with digital form preparation and also of recalling and supplying the cached data to the appropriate fields on any digital form that has been previously prepared by a user using the service. Such enhancement allows much data that would otherwise need to be supplied by a user each time a form is prepared, to be automatically supplied by proxy such that an entire, or at least most of any digital form may be data-populated transparently on behalf of users 27.

A data repository 31 is provided in this embodiment and adapted to cache information from any one of proxies 33-37. Repository 31 may be of the form of a magnetic media disk, an optical storage facility, or any other type of known data-storage facility. Repository 31 shares connection to network 29 and is, in this embodiment, shared by portal servers 33-37.

To practice the present invention, a user 27 configures the parameters of one of portal servers 33-37 into his navigational software and selects the proxy for use such as is known in the art. When a user 27 connects to server 30 and to Internet 11, the selected proxy is invoked on behalf of the user. Now proxy 37 handles all URL requests coming from user 27.

If a user invokes a URL that proxy 37 recognizes as stored in cache 31, then the associated page may be served from cache according to prior art. However, if a WEB-page in question contains such as a log-in requirement or some other digital form, then proxy 37 will look in cache for associated data-pairs (field-name and corresponding data) that matches user 27, and an invoked URL. If data-pairs are found for an existing data-form, the corresponding data is mirrored from cache 31 into the empty fields, thus populating the form on behalf of user 27. In the case of populating log-in forms or provision of other sensitive data, such as credit card information or the like, a user 27 would typically be required to provide a master password in order to access one of proxies 33-37. Similarly, a firewall or other security provisions may be provided to network 29 protecting information stored in cache 31.

Pages containing log-in requirements and other types of forms wherein all of the data for populating them exists in cache 31 may be populated completely and submitted by one of proxies 33-37 such that it is transparent to user 27. A resulting page made available by successful log-in or form completion that does not in itself contain a digital form would be a first page served to user 27. If a subsequent page also contains a digital form that may be populated with cached data, then the subsequent form may also be transparently submitted without user 27 having to interact with that particular page. In this way, network navigation, form completion, password management, among other tasks, may be streamlined on behalf of users practicing the present invention.

Other capabilities provided by SW 39 include a capability of rotating or changing user passwords on a periodic basis as added security. A user interface capability is also provided to SW 39 for the purpose of allowing a user 27 to have limited control over the use of data held in cache 31. More detail about the capabilities of SW 39 is provided below.

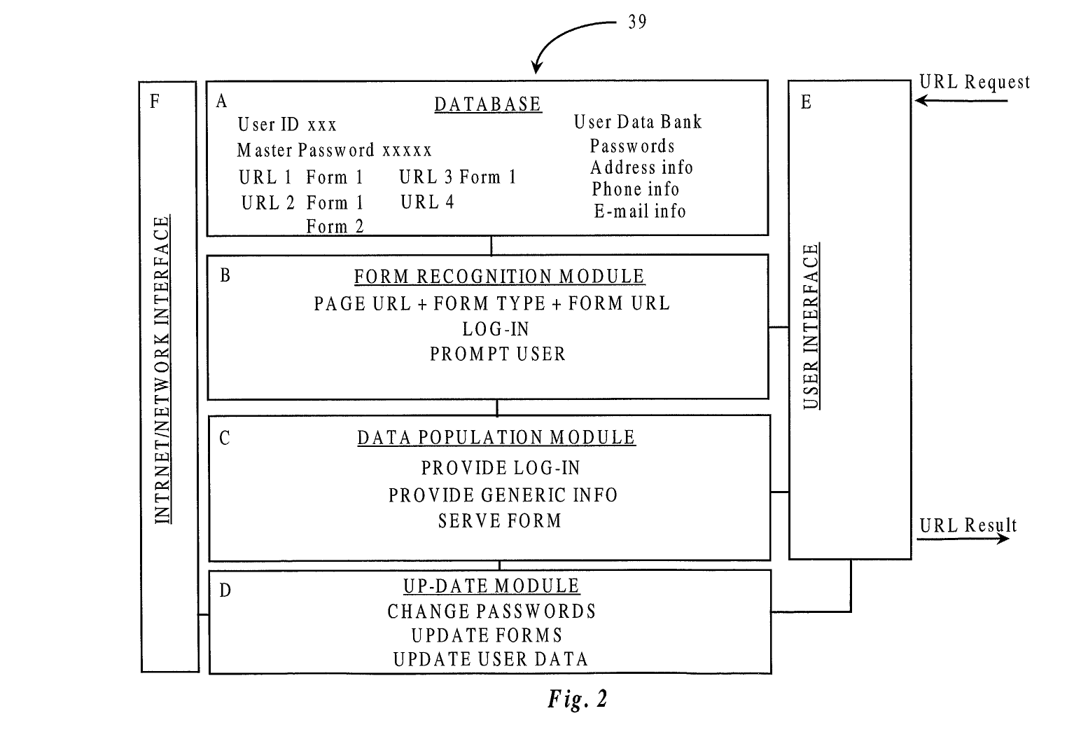

FIG. 2 is a block diagram illustrating form recognition and data population capabilities of SW 39 of FIG. 1 according to an embodiment of the present invention. Software 39 is provided as an application that executes on a host server, such as one of proxies 33-37 of FIG. 1. A database A is provided and adapted to store information regarding a user and a user's activity information. For example, each user has an identification number and a master password to authenticate him or her to the system as represented by the first two text entries in database A. A user may be identified by any known system that can be unique to each user such as by machine address, e-mail address, serial assigned number, or the like. A master password specifically identifies a user and allows him or her access to the service.

Database A maintains a cache of frequently-visited WEB pages listed by URL as indicated by further entries. If any forms are contained in a listed WEB page, they to are listed. For example, URL 1 in this example contains a single form 1. Forms may be recognized by a parsing engine as a part of software 39 and be identified by number and type of field labels. For example, a simple log-in form typically has two entry fields labeled user name and password respectively. In this way, a form may be recognized before any data has been collected to populate it such as when a first WEB page with no prior access occurrences is invoked. URL 2 has forms 1 and 2 contained therein and listed. URL 3 contains one form, and URL 4 contains no forms.

Database A also contains generic user data in a user databank with the data identifiable by at least user ID. The generic user data comprises such as user address information, user telephone information, user E-mail information, and the like. Such information is held secure by any one of several known security methods such as the use of a firewall, passwords, or the like. Data-pairs, best described as the corresponding values associated to assigned form fields, are organized and associated to the proper URL of the page and/or form. For example, URL 1 may contain a form 1 having two label fields entitled user and password. The corresponding values associated with them are the actual user's name and the password needed to proceed from that URL to the next URL. The values must be linked to the appropriate form URL to insure that data-pairs are not used at the wrong URL on identical forms.

In one embodiment, values are held in provided data blocks assigned to individual users and dedicated to one URL generic to the proper form and WEB page. In this case, a user ID tag would not be required to be included in the data. The data-block is already identified to a specific user and dedicated to storing only that user's data.

In another embodiment, values may be stored separately and tagged with a specific URL and user ID where they are exclusively used. In this case, one value may be tagged to 2 or more URLs if the same value is routinely required on forms contained therein. In this way a single value need not be listed repeatedly for every URL that contains one or more forms.

A form recognition module B is provided and adapted to recognize when there is a form contained in a WEB page. A digital form is recognized by counting the number of entry fields and parsing the titles of the entry fields. Recognition module B is invoked whenever a user initiates a URL request. Module B also monitors and parses value data that is, initially, manually entered into a form by a user, thus creating the values described above. After a user fills out a form, module B enters the value pairs into database A for subsequent use the next time a user invokes the same URL.

The parameters regarding how may visits constitutes a frequently-visited WEB page for caching purposes may vary according to user discretion. For example, WEB pages not containing forms may only be cached after several visits whereas a WEB page containing a log-in form would preferably be cached on the first visit along with values entered on the form by a user. In this way, a specific form need only be manually filled out once.

In this example, once a user 27 has populated a digital form for the first time, the data values, the form parameters, and the URL marker is cached along with the page and associated with the particular user as described above. The very next time the user invokes the same URL, the form is recognized and populated with the appropriate data, and if completed, submitted on behalf of the user in a manner transparent to the user.

A data population module C is provided in this embodiment and adapted to access data in database A and mirror the data into appropriate fields on digital forms brought into play by user invocation of cached URLs. Some digital forms may easily be completely and accurately populated such as a log-in dialog box. In a case where a form requires specific information that may vary somewhat from form to form due to a field's variable nature, such as an item part number or an order quantity, module C simply populates the form with all of the information it has, leaving variable fields blank. Completed forms (all fields filled) may be submitted transparently without serving them to a user. Uncompleted forms are sent to users for completion and submission, however, most of the work (data population) is already done saving time for the user. In this case, sending an uncompleted form to the user for completion of at most a few fields, the fields may be highlighted so the user may see them right away.

In some instances, a new WEB page will be introduced to the system that contains a generic form that asks only for generic data such as name and e-mail address. An example would be that of a free news or information service that only requires e-mail and full name to join. If a user has pre-directed the system to accept all free information service forms, then such forms may be populated and submitted without a user ever having to manually fill them out. If a user elects to be informed of the presence of such a form, then a prompt summarizing the intent of the form may be sent to the user to solicit a user directive.

An update module D is provided and adapted to allow SW 39 to be updated by a user such as one of users 27 of FIG. 1, or by another server such as server 25 in Internet network 11 (FIG. 1). Update procedures may include a user submitting a change of password for one or more of his cached sites. SW 39 may also periodically navigate to the original WEB pages that are represented in a user's data block in database A and update them for content from a host server, including any form changes that may have been made since a last update. A user may also update personal information stored in database A such as credit card numbers, address information, phone numbers, and so on.

SW 39 has a user interface module E and an Internet/network interface module F. These interface modules are adapted to allow the types of interfacing described above. To further illustrate interface capability, note that user interface module E facilitates a viable communication link between users to modules A-D. A user may, in some embodiments, be authorized to submit revisions to database A. Such revisions may include adding or deleting certain WEB pages and associated value data, changing a master password, or making corrections to generic personal data.

Form recognition module B may use interface module E to communicate to a user when it needs input from a user. For example, if a WEB page contains a form that is optional in nature, such as one that requires submission of certain personal information to receive optional advertising, then a prompt may be sent ahead of a WEB page which summarizes the nature of the form and elicits a directive response from the user. The user may also set a rule to always or never submit information in exchange for receiving advertisements.

Data population module C uses interface E to prompt a user in some embodiments. For example, if when populating a form with values, it is discovered that there are two credit card numbers stored for that form, then module C may prompt a user as to which card number to use in the form. If a user whishes only one number to be available for that URL then he or she must delete the undesired one from database A. It may be however, that two or more numbers are included in the values such that it forces an interface wherein the user may then decide which number to use based on account balance, or some other criteria.

As previously described, prior art servers offer very limited interface with users only allowed to delete or add WEB pages to the cache. However, enhanced interface capability is not specifically required to practice the present invention. A user, when practicing the present invention, may be authorized only to add to or to delete WEB pages from a cache such as cache 31. In this case however, all forms would be populated with associated values and submitted if completed. This could pose a problem with certain types of forms such as order forms. For example, if a first order using a digital order form was manually filled out by a user, and the specific values associated with random fields such as a product number and a quantity are cached in association with the URL, then the next time a user invokes the URL a duplicate order would be submitted automatically. To avoid this problem, a pre-existing rule could be programmed into module B not to cache data associated with random fields such as quantity, color, size, product number, model number, and so on. That would cause any forms containing random fields to be served uncompleted. A user could then complete the random fields and submit such forms.

In one embodiment, it may be desired that random values be cached in certain circumstances. For example if a user is a buyer who often repeats same orders for same products and quantities using a blanket purchase order number, then the random fields may be cached so that every time the user intends to place an order with that company all that is required is the invoking of the URL.

The inventor intends that a certain amount of desirable interface capability should be afforded to SW 39 in a preferred embodiment only to such an extent as to benefit a user. In a preferred embodiment all interfacing with servers enhanced with SW 39 may be accomplished without any special software on the client's end such as a browser plug-in or the like. All Internet servers have standard IP addresses and bi-directional communication abilities with other nodes including client computers as a matter of course. Such capability is known in the art and routinely utilized. This is not to say however, that a browser plug-in offering specialized interface capability could not be offered and made a part of the system. In fact, providing such an interface may allow the system to include certain URLs and associated pages that a user does not want to store in database A. In this case, a user could store some pages in such as his or her own computer cache memory while providing an access link to the proxy for the purpose of populating the forms contained in those pages. A simple URL link held in database A would alert the proxy whenever a user invokes a page from cache. At that point, the proxy could take over for the purpose of populating and submitting any forms.

It will be apparent to one with skill in the art that software 39 may be provided with more or fewer functional modules than are represented herein without departing from the spirit and scope of the present invention. For example, a configuration module could be added and adapted to allow a user to write a series of pre-directives concerning type of forms to ignore or accept, conditions covering which of several credit accounts or cards to use, and so on. The embodiment represented herein exemplifies just one example of the basic functionality of software 39 according to an embodiment of the present invention wherein the objective is to provide transparent form recognition and data-population capability.

When a user begins practicing the present invention for the first time, forms will initially be filled out manually so appropriate data values may be cached for later use. As a user progresses in routine practice of the present invention, forms having cached values will be mostly populated and served to a user for completion or completely populated and submitted to host servers by proxy in a fashion transparent to the user. More detail about form recognition and storage of data values as a user begins practice of the present invention will be provided below.

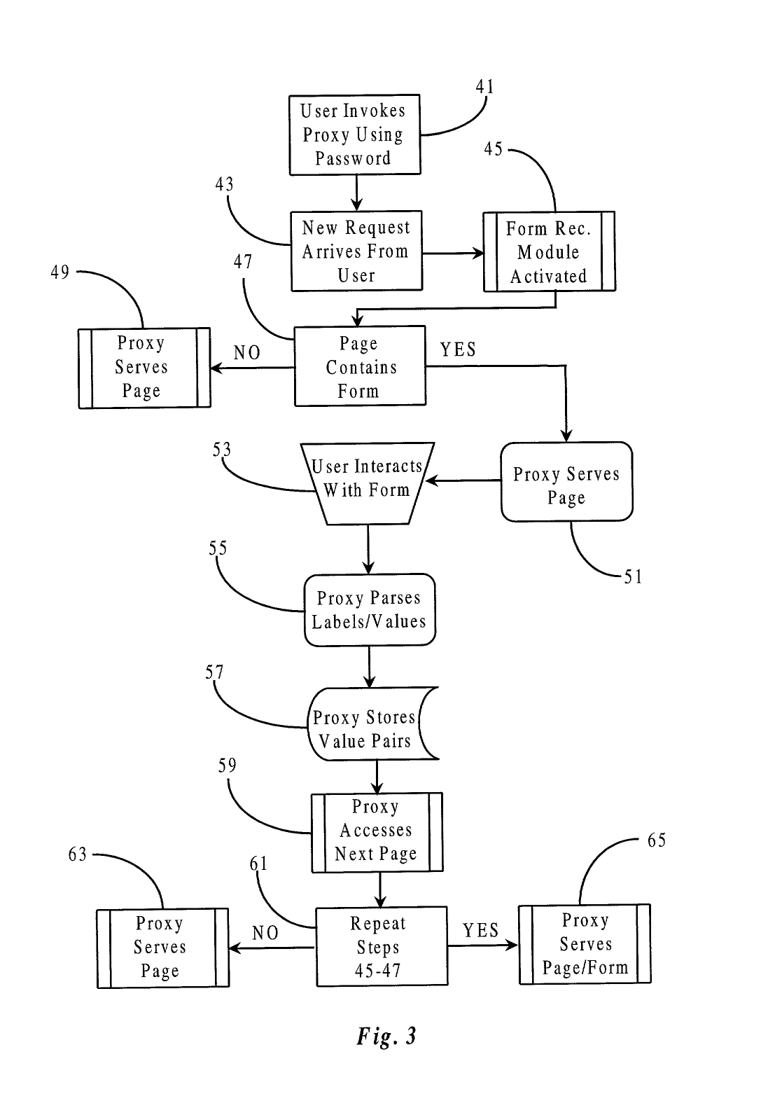

FIG. 3 is a process flow diagram illustrating logical steps for form recognition and storage of values associated with a new request according to an embodiment of the present invention.

In step 41, a user invokes a proxy such as one of proxies 33-37 (FIG. 1) by utilizing a master password that provided identification verification and authorization to use the system. After verification, a user initiates a new request by invoking a URL in step 43. In this example, the user is a beginner, therefore, it is presumed that step 43 involves a URL not yet cached into the proxy.

In step 45, a form recognition module such as module B of FIG. 2 is invoked to determine if there is a form contained in the URL page. Forms are recognized by number and title of entry fields as described in FIG. 2. Any one entry field or grouping of more than one entry field contained in a WEB page is recognized as a form. If there is no form contained in the WEB page as determined by the form-recognition module in step 47, then the WEB page is served to a user such as one of users 27 of FIG. 1 in step 49. However, if it is determined that there is a form present in the WEB page in step 47 then the WEB page containing the form is served to a user for the purpose of initial form completion in step 51.

It must be noted here that the above steps, in this example, are intended to represent the request of a new URL and form. Therefore, there is presumed to be no available data for form population in this example. In step 53, a user interacts with the form manually filling in the entry fields. In step 55 the entry fields and values from step 53 are parsed and paired as a user completes the form. Any one of several parsing engines may be used to perform parsing, and some such engines are known in the art. Such a parsing means may be included in such as form recognition module B of FIG. 2.

In step 57, the value pairs from step 55 are entered into a database such as database A of FIG. 2 on behalf of a user. In step 59, the portal server prepares to serve the next page resulting from form submission performed by a user. At step 61, steps 45 and 47 are repeated to determine if there is a form contained in the next WEB page. Steps 59 and 61 may occur simultaneously. Each page served by a portal server such as one of proxies 33-37 of FIG. 1 is first checked for the presence of a form. In some instances, the form may be completed and submitted by proxy even if no data was manually entered on that particular form and stored. This would be a case wherein the form is a generic form asking for previously stored data that is generic to a user such as contact information or the like.

At step 61, if there is no form contained in the next WEB page, then the page is served to a user in step 63. If, in step 61, it was determined that there is a form, then an attempt will be made to populate and submit the form. If the form can not be completed by proxy, then the form will be served to a user as in step 51 for user completion and submission.

It will be apparent to one with skill in the art that the process steps illustrated above may vary in description and order without departing from the spirit and scope of the present invention. For example, there may be sub-routines associated with the main process steps that perform additional services such as providing user prompts for directive response.

The flow diagram represented herein is intended to exemplify only one basic process interaction between a portal server such as one of servers 33-37 of FIG. 1 and a user practicing the present invention such as one of users 27 of FIG. 1. Furthermore, this example represents a user who is just beginning practice of the present invention and therefore must build up data in such as database A of FIG. 2 as he or she manually fills out encountered forms. However, it will be apparent to one with skill in the art that much data may be pre-entered into the system before any form interaction takes place. In such an embodiment, certain types of digital forms may be completed and submitted by proxy without prior user interaction with the form.

In general explanation of the present invention, it can be seen that as a user begins practicing the present invention, there will likely be many forms that must first be filled out manually such that specific value pairs not yet known to the system may be stored and later used to populate subsequent forms of the same type. The above embodiment exemplifies that scenario. However, after routine practice of the present invention over time, more value data is stored for subsequent use allowing for increasingly more instances of automated data population of forms to occur. Such a scenario will be exemplified in detail below.

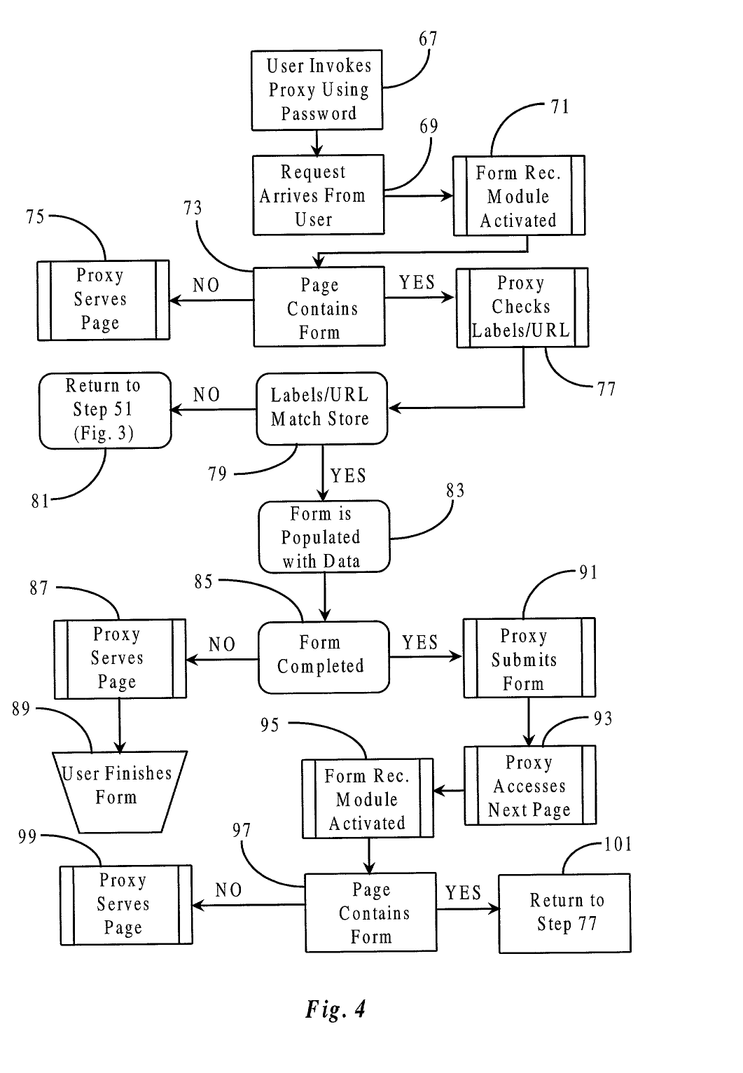

FIG. 4 is a process flow diagram illustrating logical steps for form recognition and data population associated with a repeat request according to an embodiment of the present invention. At step 67, a user such as one of users 27 (FIG. 1) invokes a portal server such as one of servers 33-37 (FIG. 1) and is authenticated by using a master password. As previously described, the master password allows the system to verify the user in a secure environment and authorizes the system to use any of the users stored passwords classified as value data. At step 69, a URL request arrives from a user.

In step 71, a form recognition module such as module B (FIG. 2) is activated as is the case with all URL requests whether they are already cached in such as database A (FIG. 2) or not. In step 73, it is determined if the requested WEB page contains a form. If not, the page is served to a requesting user in step 75. If however, it is determined in step 73 that a requested WEB page does contain a form, then the proxy checks for label-value pairs under the URL and user ID in the database in step 77.

If appropriate data (URL, value pairs, user ID) required to match a requested URL/form is not found in step 79, then it is likely a new page and form to the system and therefore, the process resolves to step 51 of FIG. 3 wherein the form is served to a requesting user for completion and submission. It is noted here that if a suspect WEB page is recognized in step 71 as not being cached but a form contained therein is recognized as generic such that it may be populated with data values that are known to the system, then it may be completed and submitted by proxy.

If in step 79, a requested WEB page and entry labels associated with a form contained therein match information held in cache and associated with the proper user ID, then the form is populated with the data values from cache by such as the data population module C (FIG. 2) in step 83. If however, a form cannot be completed as determined in step 85, then a requested page including any form contained therein is served by proxy to a requesting user at step 87. Step 87 is analogous to step 51 of FIG. 3. At step 89, a requesting user must finish and submit any forms that are served uncompleted.

If at step 85, it is determined that a form was completely data populated by proxy, then it is submitted, in step 91, on behalf of a requesting user. At step 93 a next WEB page resulting from the form submission of step 91 is prepared for service in step 93, if available. It is duly noted here that not all WEB pages containing digital forms are linked to a subsequent page. This is a fact that will be readily apparent to one with skill in the art. At step 95, the form recognition module of step 71 is activated for a next WEB page. Steps 95 and 93 occur simultaneously before the page is actually served to a requesting user.

At step 97, it is determined if the resulting WEB page contains a form. If it does not, the page is served by proxy in step 99. If it is determined in step 97 that the page does contain a form, then the process moves to step 101, which returns to step 77, wherein URL and label data is checked against cache for a WEB page and value pairs. The process repeats itself from step 77.

It will be apparent to one with skill in the art that the process steps illustrated above may vary in description and order without departing from the spirit and scope of the present invention. For example, there may be sub-routines associated with the main process steps that perform additional services such as providing user prompts for directive response. Other process routines may also be provided and integrated into the flow diagrams represented by FIGS. 3 and 4 above without departing from the spirit and scope of the present invention. For example, a routine for periodically rotating or changing user passwords may be included. Furthermore, routines for updating cached WEB pages, updating forms, revising generic data, and the like may be written as separate routines or integrated routines that may execute automatically or be executed manually by a user during the course of practicing the present invention. In an alternative embodiment, a configuration process may be followed with new subscribers wherein subscribers are prompted to provide information pertinent to forms, which is then stored as a part of a user-specific profile, which is then subsequently used by the subscription server to fill in forms for a user.

The method and apparatus of the present invention is not limited to a typical proxy scenario wherein WEB pages are actually cached and held for a user. For example, a database such as database A may be adapted to only hold user and value data pairs along with a URL link to the requested WEB page. In this embodiment, a server would not serve a cached page. The server would instead navigate to the original destination of the requested page on behalf of the requesting user. The server would then download the requested page and perform it's automated routines by virtue of SW 39 on behalf of the user. By not performing as a true portal server, some download time originally saved for a user by virtue of caching entire WEB pages will be added to the overall process. However, a user who works with many forms will still appreciate that much time may still be saved by virtue of the automated data population and submission of such forms even though each page is downloaded from the original source before forms are prepared and submitted.

The method and apparatus of the present invention may be practiced as a service that is hosted on a digital sub-net connected to the Internet or another WAN as was described in FIG. 1. In another embodiment, servers such as servers 33-37 (FIG. 1) may be geographically distributed throughout the Internet or over a WAN instead of being localized.

The method and apparatus of the present invention may be practiced on a wide variety of architectures. A service made possible by the provisions of present invention and offered by any one of a variety of hosting entities may be subscribed to by anyone operating an Internet or network appliance capable of connecting to and browsing the Internet or network. Such a subscriber may practice the present invention, in most embodiments, without downloading any special software. In other embodiments, a dedicated software application such as a plug-in may be offered in addition to SW 39.

The method and apparatus of the present invention should be afforded the broadest scope possible. The spirit and scope of the present invention is limited only by the claims that follow.

What is claimed is:

1. A subscription server system comprising:
an Internet-connected subscription server;
a user station subscriber to the subscription server, the user station enabled to connect-to the Internet and to invoke Universal Resource Locators (URLs) for WEB server destinations on the Internet; and
a data repository accessible to the subscription server storing data pertinent to the user station;
wherein the subscription server monitors URL destinations invoked by the user station and pages served by the WEB server destinations to the user station as a result of the URLs invoked, intercepts forms requested by the WEB server destinations, populates fields in the forms with data from the data repository pertinent to the user station, and submits the forms to the requesting WEB server destinations on behalf of the user station, transparent to the user station.

2. The subscription server system of claim 1 wherein one of the forms populated by the subscription server for the user station is a log-in form requested by one of the WEB server destinations.

3. The subscription server system of claim 1 wherein form data is submitted by user/subscribers in user profiles stored in the data repository and accessed by the subscription server to fill out forms.

4. The subscription server system of claim 1 wherein the subscription server identifies forms served to the user, and after a user fills out a form, the subscription server copies and stores the form and data for future use.

5. The subscription server system of claim 4 wherein the subscription server, in monitoring user activity, recognizes a form previously requested by a WEB server destination and filled out by the user, and retrieves the stored copy of the filled-out form and communicates it to the requesting server.

6. The subscription server system of claim 1 wherein the user performs a single log-in for the subscription server, and the subscription server, through pre-stored data associated with the user, provides subsequent log-ins for the user during a browsing session.

7. The subscription server system of claim 6 wherein the subscription server changes passwords on a pre-programmed basis for the user, thereby enhancing user security.

8. The subscription server system of claim 1 wherein the subscription server is enhanced by a form-recognition module enabled to store standards for forms and to use the standards to recognize subsequent forms.

9. The subscription server system of claim 5 wherein the subscription server recognizes fields requiring variable information in a form, provides user information for fields requiring non-variable information, and submits the form to the user to fill in the variable information.

10. A software suite for a subscription server serving as a browsing proxy for a user, the software suite comprising:
a data storage and retrieval module enabled to communicate with a data repository wherein are stored copies of forms filled out by the user;
a form-recognition module enabled to recognize blank forms served to the user by a requesting WEB server as equivalent to individual ones of the stored forms; and
a substitution module enabled to retrieve a filled-out form copy of a blank form served to a user, and to submit the filled-out copy to the requesting server on behalf of the user, transparent to the user.

11. The software suite of claim 10 wherein the form-recognition module monitors the process of a user filling in a form, and the storage and retrieval module, after the user once fills in the form, stores data particular to the form to be used the next time the form is recognized in conjunction with the user.

12. The software suite of claim 10 further comprising a password module that stores passwords particular to a user and the user's WEB destinations, and submits the passwords for the user, transparent to the user.

13. The software suite of claim 12 wherein the password module changes passwords for the user periodically, enhancing security for the user.

14. The software suite of claim wherein the form-recognition module recognizes fields requiring variable information in a form, provides user information for fields requiring non-variable information, and submits the form to the user to fill in the variable information.

15. A method for relieving subscribers of repeated form-filling tasks in WEB browsing, comprising steps of:
(a) monitoring a subscriber's browsing activity on the WEB by software on a subscription server;
(b) recognizing, by the subscription server, a form sent to the subscriber by a WEB server for the subscriber to fill out;
(c) retrieving from a data repository data pertinent to the subscriber and the form; and
(d) submitting, by the subscription server to the WEB server, a filled-out form on behalf of the subscriber.

16. The method of claim 15 wherein in step (b) the subscription server recognizes in addition that the form has fields requiring variable information not available to the subscription server, and further comprising a step for filling in non-variable information and submitting the form to the subscriber to fill in the variable information before submitting the form to the requesting server on behalf of the subscriber.

17. A method for enhancing security for a person browsing the WEB, comprising steps of:
(a) configuring the person as a subscriber to a WEB-based subscription service with a single secure log in procedure;
(b) storing for the person security data associated with individual ones of frequent WEB destinations;
(c) monitoring the person's WEB browsing activity; and
(d) submitting for the person for the WEB destinations when recognized, the security data associated with the person and the WEB destination.

18. The method of claim 17 wherein security data for the person is altered on a periodic basis to further enhance security for the person.
